(19) United States
(12) Patent Application Publication
(10) Pub. No.: US 2015/0159522 A1
(43) Pub. Date: Jun. 11, 2015

(54) ROLLING BEARING WITH RADIAL PRESSURE MEDIUM TRANSFER

(71) Applicant: Schaeffler Technologies GmbH & Co. KG, Herzogenaurach (DE)

(72) Inventors: Ali Bayrakdar, Roethenbach/Pegnitz (DE); Joachim Dietz, Frensdorf (DE); Gerhard Scheidig, Oberasbach (DE); Andreas Strauss, Forchheim (DE)

(21) Appl. No.: 14/405,117

(22) PCT Filed: Jul. 10, 2013
(86) PCT No.: PCT/DE2013/200036

§ 371 Date: Dec. 2, 2014

(30) Foreign Application Priority Data
Aug. 23, 2012 (DE) 10 2012 214 960.0

(51) Int. Cl. F01L 1/344; F16C 33/38; F16C 33/58

(52) U.S. Cl. CPC F01L 1/3442; F16C 33/586; F16C 33/38; F01L 2001/34423

(57) ABSTRACT

A rolling bearing (50) which includes a rolling bearing inner ring (51), a rolling bearing outer ring (52) and a rolling bearing ball cage ring (53). The aim of the invention is to enable a hydraulic pressure medium (P) to be transferred, economizing as much mounting space as possible, for example for a camshaft (10), the phase position thereof being adjustable in relation to a crankshaft via a hydraulic pressure medium (P) through a hydraulic phase adjusting device (20). The rolling bearing (50) includes at least one channel (51a, 51a′, 52a′, 41, 42) for guiding hydraulic pressure medium (P). A camshaft assembly equipped with such a rolling bearing (50).

The present invention relates to a rolling bearing and a camshaft assembly.

### BACKGROUND INFORMATION

Camshafts are used in valve train assemblies of internal combustion engines for the purpose of controlling the opening and/or closing of inlet valves and/or outlet valves in a targeted manner. The camshaft is driven by a crankshaft.

Adjustment of the phase angle of the camshaft with respect to the crankshaft may take place with the aid of a hydraulic phase adjusting device which is placed, for example, in or on the camshaft and which is supplied with a hydraulic pressure medium such as motor oil, for example via the oil pump of the internal combustion engine. Pressure medium-conducting channels may be formed in the camshaft for the purpose of supplying the hydraulic phase adjusting device with the hydraulic pressure medium.

Publication EP 2 326 804 B1 describes a camshaft assembly, in which a hydraulic phase adjusting device is supplied with pressure medium via a radial channel in the camshaft.

### SUMMARY OF THE INVENTION

It is an object of the present invention to provide a preferably installation space-saving option for transferring a hydraulic medium, for example for a camshaft whose phase angle with respect to a crankshaft is adjustable with the aid of a hydraulic pressure medium, using a hydraulic phase adjusting device.

The present invention provides a rolling bearing which has a rolling bearing inner ring, a rolling bearing outer ring and a rolling bearing ball cage ring and which includes at least one channel for conducting a hydraulic pressure medium. Due to the at least one channel, a hydraulic pressure medium may be advantageously conducted in an installation space-saving manner.

For example, the rolling bearing inner ring may be designed to be rotatable and the rolling bearing outer ring to be stationary, or the rolling bearing inner ring may be designed to be stationary and the rolling bearing outer ring to be rotatable. The rolling bearing ball cage ring may be designed to be both stationary and rotatable or to be loosely or floatingly supported.

The rolling bearing may be used, for example, for the purpose of, in particular rotatable, support of a camshaft. The camshaft may be, in particular, a camshaft whose phase angle with respect to a crankshaft is adjustable with the aid of a hydraulic pressure medium, for example using a hydraulic phase adjusting device. The hydraulic phase adjusting device may be designed, for example, as a vane-type adjuster. For example, the hydraulic phase adjusting device may be situated at least partially within the camshaft or its interior and/or be supplied with the hydraulic pressure medium via the interior of the camshaft. For this purpose, the camshaft may include, for example, at least one radial channel.

In particular, the rolling bearing may be designed to transfer a hydraulic pressure medium from a stationary component to a rotatable component. For example, a pressure medium channel formed in a stationary component, for example in a cylinder head-affixed component, may communicate with the phase adjusting device via the at least one channel of the rolling bearing. For example, the pressure medium channel may communicate with the phase adjusting device via the at least one channel of the rolling bearing and at least one radial channel of the camshaft and/or the interior of the camshaft. The pressure medium channel may also be, for example, a radial channel.

A cylinder head-affixed component may be understood, in particular, to be a component which is immovably situated on the cylinder head. This component may be, for example, the cylinder head, a cylinder head cover, a crankcase, a chain case or an ancillary component connected to these components.

Communicating may be understood to be a direct pressure medium transfer as well as an indirect pressure medium transfer, for example via one or multiple additional, for example interposed, openings, channels and/or components.

Within the scope of one specific embodiment, the rolling bearing includes at least one pressure medium transfer element. The pressure medium transfer element may be, in particular, an independent component or an independent component arrangement. The pressure medium transfer element may be situated loosely or floatingly supported in the rolling bearing or fastened to a rolling bearing component, for example to the rolling bearing inner ring or to the rolling bearing outer ring or to the rolling bearing ball cage ring. The pressure medium transfer element may be, in particular, an annular component or an annular component arrangement.

Within the scope of another specific embodiment, on the other hand, at least one rolling bearing component, in particular the rolling bearing inner ring and/or the rolling bearing outer ring and/or the rolling bearing ball cage ring, itself is used to transfer the hydraulic pressure medium.

Within the scope of one preferred specific embodiment, at least one pressure medium transfer element and/or rolling bearing component, in particular the rolling bearing inner ring and/or the rolling bearing outer ring and/or the rolling bearing ball cage ring, includes at least one annular channel for the purpose of transferring the hydraulic pressure medium, in particular, between a stationary component and a rotatable component.

In particular, the at least one annular channel of the pressure medium transfer element or the rolling bearing component may have an annular channel opening extending in the circumferential direction of the annular channel and at least one radial channel opening opposite the annular channel opening and emptying into a radial channel.

A pressure medium transfer between a stationary component and a rotatable component may advantageously take place in a simple, reliable and installation space-saving manner via the annular channel opening and the at least one radial channel opening of the at least one annular channel of the pressure medium transfer element or the rolling bearing component. In particular, at least one pressure medium channel in a stationary component, for example a cylinder head-affixed component, may communicate with at least one channel in the rotatable component, for example the camshaft, via the annular channel opening and radial channel opening(s) of the annular channel of the pressure medium transfer element.

Within the scope of another preferred specific embodiment, at least one pressure medium transfer element and/or rolling bearing component, in particular the rolling bearing inner ring and/or the rolling bearing outer ring and/or the rolling bearing ball cage ring, includes at least one radial channel which empties into a radial channel opening of the at least one annular channel of the pressure medium transfer element or the rolling bearing component.

The at least one pressure medium transfer element and/or rolling bearing component may include both one annular channel and two or more annular channels. It is also possible for two or possibly more radial channels to be provided.

In particular, the rolling bearing may include two or more components, which each include at least one annular channel, in particular having an annular channel opening extending in the circumferential direction of the annular channel, and at least one radial channel opening opposite the annular channel opening and emptying into a radial channel, and, if necessary, at least one radial channel emptying into a radial channel opening of the annular channel. For example, the rolling bearing may include two pressure medium transfer elements of this type or one pressure medium transfer element of this type and one rolling bearing component of this type or two rolling bearing components of this type. For example, the rolling bearing inner ring and the rolling bearing outer ring or the rolling bearing ball cage ring and the rolling bearing inner ring and/or the rolling bearing outer ring may each be designed in this way. The pressure medium transfer among the components may take place via the annular channel openings and radial channel openings of the annular channels. In particular, annular channels of different components may empty into each other and have, for example, annular channel openings which are situated opposite each other, in particular directly adjacent to each other.

In principle, it is possible to fasten the pressure medium transfer element or the rolling bearing component in an angle-oriented manner. To dispense with an angle-oriented mounting, it may, however, be advantageous to provide one or multiple additional (mounting) annular channels and/or one or multiple additional (mounting) radial channels, for example having radial channel openings which are enlarged axially and/or in the circumferential direction. Due to the additional (mounting) annular channels and/or (mounting) radial channels, mounting tolerances may be advantageously compensated for and the mounting simplified thereby.

For example, the at least one radial channel of the pressure medium transfer element or the rolling bearing component may empty into another (mounting) annular channel and/or another (mounting) radial channel having enlarged radial channel openings, for example which has an opening provided in an outer surface of the component. The additional (mounting) annular channel or (mounting) radial channel may be formed in the pressure medium transfer element or rolling bearing component or in a component adjacent thereto and having a channel, for example the camshaft or a cylinder head-affixed component.

At least one pressure medium transfer element and/or rolling bearing component, in particular the rolling bearing inner ring and/or the rolling bearing outer ring and/or the rolling bearing ball cage, preferably includes at least one annular channel having a radially outer annular channel opening and, in particular, at least one radially inner radial channel opening and/or at least one annular channel having a radially inner annular channel opening and, in particular, at least one radially outer radial channel opening.

The terms outer and inner refer to the particular annular channel, the term radial also referring to the rotationally symmetrical axis of the particular annular channel or also to the rotation axis of the camshaft or the rolling bearing or possibly of the camshaft.

Within the scope of another preferred specific embodiment, at least one pressure medium transfer element and/or rolling bearing component, in particular the rolling bearing inner ring and/or the rolling bearing outer ring and/or the rolling bearing ball cage ring, includes at least one annular channel having a radially outer annular channel opening. In particular, the annular channel may have at least one radially inner radial channel opening.

Within the scope of one special embodiment, at least one pressure medium transfer element and/or rolling bearing component, in particular the rolling bearing inner ring and/or the rolling bearing outer ring and/or the rolling bearing ball cage, includes at least one annular channel having a radially outer annular channel opening and, in particular, at least one radially inner radial channel opening, an annular channel having a radially inner annular channel opening and, in particular at least one radially outer radial channel opening as well as at least one radial channel which connects the annular channel having the radially outer annular channel opening to the annular channel having the radially inner annular channel opening. The at least one radial channel may empty, in particular, into the at least one radial inner radial channel opening of the annular channel having the radially outer annular channel opening and into the at least one radially outer radial channel opening of the annular channel having the radially inner annular channel opening. The annular channel having the radially outer annular channel opening and, in particular, the at least one radially inner radial channel opening may be, for example, an annular channel which is formed with the radially inner annular channel opening and the at least one radially outer radial channel opening radially outward from the annular channel, it being possible to refer to the annular channel having the radially outer annular channel opening as the outer annular channel and the annular channel having the radially inner annular channel opening as the inner annular channel.

This embodiment has the advantage, on the one hand, that it may be situated, loosely or floatingly supported, for example between the stationary component and the rotatable component, for example between the rolling bearing inner ring and the rolling bearing outer ring or between a rolling bearing component and the cylinder head-affixed component or the camshaft or between the cylinder head-affixed component and the camshaft, it being possible to both facilitate a pressure medium transfer between a stationary component and a rotating component and to dispense with an angle-oriented alignment, due to the two annular channels.

On the other hand, if this embodiment is fixedly connected to a component or integrated therein, this has proven to be advantageous, since it facilitates a pressure medium transfer between a stationary component and a rotating component via the one annular channel and may be fastened via the surface having the other annular channel, without taking into account an angle-oriented alignment, whereby the mounting may be advantageously simplified.

The rolling bearing may include a component of this type, for example a pressure medium transfer element of this type or a rolling bearing component of this type, for example a rolling bearing inner ring or rolling bearing outer ring or rolling bearing ball cage ring of this type. A pressure medium transfer element of this type may be situatable or situated, for example, between the rolling bearing inner ring and the rolling bearing outer ring, or between the rolling bearing inner ring or the rolling bearing outer ring and the cylinder head-affixed component, or between the rolling bearing outer ring or the rolling bearing inner ring and the camshaft. A rolling bearing inner ring of this type may be situatable or situated, for example, between the camshaft and the rolling bearing ball cage ring or the rolling bearing outer ring or the cylinder head-affixed component. A rolling bearing outer ring of this type may be situatable or situated, for example, between the cylinder head-affixed component and the rolling bearing ball cage ring or the rolling bearing inner ring or the camshaft. A rolling bearing ball cage ring of this type may be situatable or situated, for example, between the rolling bearing inner ring or the camshaft and the rolling bearing outer ring or the cylinder head-affixed component. The pressure medium transfer element or rolling bearing component may be loosely or floatingly supported or fastenable or fastened to a rotatable or stationary component. For example, one of the annular channels of the pressure medium transfer element or rolling bearing component may communicate with a channel of a stationary or rotatable, in particular stationary, component, for example a pressure medium channel of a cylinder head-affixed component, or empty therein, in particular radially, for example directly or indirectly, via an annular channel opening, for example, the annular channel opening being situated opposite, in particular directly adjacent to, an opening of the channel of the component. The other annular channel of the pressure medium transfer element or rolling bearing component may communicate with a channel of a rotatable or stationary, in particular rotatable, component, for example one or multiple radial channels of the camshaft, or empty therein, in particular radially, for example directly or indirectly, via an annular channel opening, for example, the annular channel opening being situated opposite, in particular directly adjacent to, an opening of the channel of the component.

It is furthermore possible that the rolling bearing has two or more components of this type. For example, the rolling bearing may include two pressure medium transfer elements of this type or one pressure medium transfer element of this type and one rolling bearing component of this type or two rolling bearing components of this type. For example, the rolling bearing inner ring and the rolling bearing outer ring or the rolling bearing ball cage ring and the rolling bearing inner ring and/or the rolling bearing outer ring may each be designed in this way. Or the rolling bearing includes a pressure medium transfer element of this type and a rolling bearing inner ring or rolling bearing outer ring or rolling bearing ball cage ring of this type. For example, one of the components may be rotatable, for example fastenable to the camshaft, or fastened to the rotatable rolling bearing ring, or it may be the rotatable rolling bearing ring itself, or it may be loosely or floatingly supported, for example fastened to the rolling bearing ball cage ring, in particular to an axial surface of the rolling bearing ball cage ring, or it may be the rolling bearing ball cage ring itself or it may be situated adjacent to the rolling bearing ball cage ring. The other component may be stationary, for example, fastenable to the cylinder head-affixed component, or fastened to the stationary rolling bearing ring, or it may be the stationary rolling bearing ring itself, or it may be loosely or floatingly supported, for example fastened to the rolling bearing ball cage ring, in particular to an axial surface of the rolling bearing ball cage ring, or it may be the rolling bearing ball cage ring itself or it may be situated adjacent to the rolling bearing ball cage ring. An annular channel of the rotatably/floatingly supported component facilitates a pressure medium transfer to an annular channel of the stationary/floatingly supported component. For example, the radially inner annular channel opening of the annular channel of the one, for example stationary/floatingly supported, component may be situated opposite, in particular directly adjacent to, the radially outer annular channel opening of the annular channel of the other, for example rotatably/floatingly supported component. An angle-oriented mounting may be advantageously dispensed with, due to the surfaces in which the annular channel openings of the two other annular channels of the components are formed (see FIG. 4).

Within the scope of one particularly special embodiment, the rolling bearing inner ring includes an annular channel having a radially outer annular channel opening and, in particular, at least one radially inner radial channel opening, an annular channel having a radially inner annular channel opening and, in particular, at least one radially outer radial channel opening as well as at least one radial channel which connects the annular channel having the radially outer annular channel opening of the rolling bearing inner ring to the annular channel having the radially inner annular channel opening of the rolling bearing inner ring, in particular the least one radial channel of the rolling bearing inner ring emptying into the at least one radially inner radial channel opening of the annular channel having the radially outer annular channel opening of the rolling bearing inner ring and into the at least one radially outer radial channel opening of the annular channel having the radially inner annular channel opening of the rolling bearing inner ring.

The rolling bearing outer ring also includes an annular channel having a radially outer annular channel opening and, in particular, at least one radially inner radial channel opening, an annular channel having a radially inner annular channel opening and, in particular, at least one radially outer radial channel opening as well as at least one radial channel which connects the annular channel having the radially outer annular channel opening of the rolling bearing outer ring to the annular channel having the radially inner annular channel opening of the rolling bearing outer ring, in particular the least one radial channel of the rolling bearing outer ring emptying into the at least one radially inner radial channel opening of the annular channel having the radially outer annular channel opening of the rolling bearing outer ring and into the at least one radially outer radial channel opening of the annular channel having the radially inner annular channel opening of the rolling bearing outer ring.

The radially outer annular channel opening of the annular channel of the rolling bearing inner ring is situated opposite, in particular directly adjacent to, the radially inner annular channel opening of the annular channel of the rolling bearing outer ring.

The annular channel having the radially inner annular channel opening of the rolling bearing inner ring may communicate with a channel of a rotatable or stationary, in particular rotatable, component, for example with at least one radial channel of the camshaft, or the annular channel having the radially outer annular channel opening of the rolling bearing outer ring may communicate with a channel of a stationary or rotatable, in particular stationary, component, for example with a pressure medium channel of a cylinder head-affixed component. In particular, the annular channel having the radially inner annular channel opening of the rolling bearing inner ring may empty, in particular radially, into a channel of a rotatable or stationary, in particular rotatable, component, for example into one or multiple radial channels of the camshaft, for example, the radially inner annular channel opening of the rolling bearing inner ring being situated opposite, in particular directly adjacent to, a radially outer opening of the channel of the component, for example one or multiple radially outer radial channel openings of the camshaft. The annular channel having the radially outer annular channel opening of the rolling bearing outer ring may empty, in particular radially, into a channel of a stationary or rotatable, in particular stationary, component, for example into the pressure medium channel of the cylinder head-affixed component, for example, the radially outer annular channel opening of the rolling bearing outer ring being situated opposite, in particular adjacent to, a radially inner opening of the channel of the component, for example a radially inner opening of the pressure medium channel of the cylinder head-affixed component.

Within the scope of another special embodiment, a pressure medium transfer element or a rolling bearing ball cage ring is situated between the rolling bearing inner ring and the rolling bearing outer ring, which includes at least one annular channel, in particular having an annular channel opening extending in the circumferential direction of the annular channel, and at least one radial channel opening opposite the annular channel opening and emptying into a radial channel and at least one radial channel which empties into a radial channel opening of at least one annular channel of the pressure medium transfer element or the rolling bearing ball cage ring. The pressure medium transfer element may be situated, for example, loosely or floatingly supported, for example adjacent to the rolling bearing ball cage ring or fastened to the rolling bearing ball cage ring, in particular to an axial surface of the rolling bearing ball cage ring. If the pressure medium transfer element is fastened to the rolling bearing call cage ring, the pressure medium transfer element may be situated in a stationary or rotatably or loosely/floatingly supported manner as a function of the rolling bearing ball cage.

In particular within the scope of this embodiment, the rolling bearing inner ring and the rolling bearing outer ring may (each) include a radial channel. The radial channel of the rolling bearing outer ring may communicate with the radial channel of the rolling bearing inner ring via the pressure medium transfer element or the rolling bearing ball cage ring, in particular via the at least one annular channel and radial channel of the pressure medium transfer element or the rolling bearing ball cage ring.

On the other hand, the radial channel of the rolling bearing inner ring may communicate with a channel of a rotatable or stationary, in particular rotatable, component, for example with one or multiple radial channels of the camshaft, or the radial channel of the rolling bearing outer ring may communicate with a channel of a stationary or rotatable, in particular stationary, component, for example with a pressure medium channel of a cylinder head-affixed component.

In particular, the radial channel of the rolling bearing inner ring may empty into a channel of a rotatable or stationary, in particular rotatable, component, for example into one or multiple radial channels of the camshaft, in particular radially, for example directly or indirectly, for example via another (mounting) annular channel and/or (mounting) radial channel having radial channel opening(s) which are enlarged, for example, in the circumferential direction and/or axially, for example, a channel opening of the rolling bearing inner ring being situated opposite, in particular directly adjacent to, an opening of the channel of the component, for example one or multiple radial channel openings of the camshaft. The radial channel of the rolling bearing outer ring may empty into a channel of a stationary or rotatable, in particular stationary, component, for example into the pressure medium channel of the cylinder head-affixed component, in particular radially, for example directly or indirectly, for example via another (mounting) annular channel and/or (mounting) radial channel having radial channel opening(s) which are enlarged, for example, axially and/or in the circumferential direction, for example, a channel opening of the rolling bearing outer ring being situated opposite, in particular directly adjacent to, an opening of the channel of the component, for example an opening of the pressure medium channel of the cylinder head-affixed component. The additional (mounting) annular channel and/or (mounting) radial channel may have, for example, an opening formed in an inner lateral surface of the rolling bearing inner ring or in an outer lateral surface of the rolling bearing outer ring. For example, the additional (mounting) annular channel and/or (mounting) radial channel may be formed in the rolling bearing inner ring radially inwardly of the radial channel of the rolling bearing inner ring or in the rolling bearing outer ring radially outwardly of the radial channel of the rolling bearing outer ring.

The pressure medium transfer element or the pressure medium transfer elements may include an annular base body in the form of an annular U profile or H profile having an essentially axially oriented profile middle section, at least one radial channel extending through the profile middle section. The at least one radial channel may be designed, for example, in the form of a continuous material recess, for example a bore. Due to the profile middle section and two profile side sections connected thereto, one annular channel may be provided in the case of a U profile or two annular channels may be provided in the case of an H profile. This embodiment has the advantage, on the one hand, that the pressure medium transfer element may be easily manufactured. On the other hand, an annular base body designed in this way may simultaneously function as a compression seal, as explained in greater detail below.

A U profile may be understood to be, in particular, a profile having an essentially U-shaped cross-sectional surface. An H profile may be understood to be, in particular, a profile having an essentially H-shaped cross-sectional surface. Essentially may be understood to mean, in particular, that, to the extent that the lateral sections of the cross-sectional surface have a similar, in particular radial, extension to each other, the intermediate profile middle section may have shape deviations and may be provided, for example, with a wavy design. A wavy design of the profile middle section has the advantage that a compression seal and/or another annular groove and/or seal receptacles may be provided thereby (see FIGS. 5 through 7).

However, the pressure medium transfer element or the pressure medium transfer elements may also include an annular base body, in which the at least one annular channel is provided in the form of an annular groove, at least one radial channel, which empties into the at least one annular groove-shaped annular channel, extending through the annular base body. The at least one radial channel may be designed, for example, in the form of a continuous material recess, for example a bore, which empties into the at least one annular groove-shaped annular channel. In particular, two annular channels in the form of annular grooves may be provided in the annular base body, at least one radial channel, which empties into the two annular groove-shaped annular channels, extending through the annular base body.

The annular base body may be made of metal or plastic, in the case of a design as a profile as well as in the case of a design as a component having an annular groove. For example, the annular base body may be a formed part, a cast part or a turned part. For example, the annular base body may be a metal sheet, for example a sheet metal ring, or a metal or plastic cast part.

For the purpose of sealing the pressure medium transfer system, the pressure medium transfer element or the rolling bearing component designed for pressure medium transfer may be equipped, for example, with sealing rings and/or be designed as compression seals and/or be provided with one or multiple clearance fits.

A sealing of the pressure medium transfer system may take place within the rolling bearing, in particular with the aid of one or multiple clearance fits, in particular with the aid of at least one clearance fit between the rolling bearing inner ring and the rolling bearing outer ring.

The pressure medium transfer element or the rolling bearing component designed for pressure medium transfer may be sealed against one or multiple adjacent components to be sealed with respect thereto, with the aid of one or multiple clearance fits.

Alternatively or additionally, however, it is also possible that the pressure medium transfer element or the rolling bearing component designed for pressure medium transfer (each) includes at least two sealing rings, which extend, in particular essentially in parallel, to both sides of an annular channel. In particular, two sealing ring receptacles formed on both sides of an annular channel, for example in the form of annular indentations, may be provided for accommodating the sealing rings.

If the pressure medium transfer element or the rolling bearing component designed for pressure medium transfer includes two annular channels and is fixedly connected to another component via a surface having an annular channel, or if it is integrated therein, it is possible to provide sealing rings or sealing ring receptacles only on the two sides of one of the annular channels, namely the annular channel formed in an unconnected surface.

If the pressure medium transfer element or the rolling bearing body designed for pressure medium transfer has two annular channels and is a loosely or floatingly supported component or a loosely or floatingly supported component arrangement, it is possible to provide two sealing rings or sealing ring receptacles on both sides of both annular channels, i.e., a total of at least four sealing rings or sealing ring receptacles.

Alternatively or additionally, however, it is also possible that the pressure medium transfer element or the rolling bearing component designed for pressure medium transfer itself functions as a compression seal, a section of the pressure medium transfer element or the rolling bearing component designed for pressure medium transfer being pressable against an adjacent component to be sealed with respect thereto for the purpose of achieving a sealing effect upon application of pressure medium and, if necessary, upon deformation. The component to be sealed, for example the cylinder head-affixed component, or the camshaft or the rotatable or stationary rolling bearing ring, may have a compression sealing contact and/or accommodating section, which, if necessary, is also used for the purpose of, in particular, radial and/or axial stabilization of the position of or blocking of the compression seal section of the pressure medium transfer element or of the rolling bearing component designed for pressure medium transfer.

The present invention also provides a camshaft assembly which includes a camshaft, a hydraulic phase adjusting device for adjusting the phase angle of the camshaft with respect to a crankshaft with the aid of a hydraulic pressure medium, a pressure medium channel formed in a stationary component, in particular in a cylinder head-affixed component, as well as a rolling bearing according to the present invention. In particular, the pressure medium channel may communicate with the phase adjusting device via the at least one channel of the rolling bearing.

The camshaft may be rotatably supported, in particular, by the rolling bearing.

For example, the camshaft may include, for example, at least one radial channel. The pressure medium channel may communicate with the phase adjusting device, in particular, via the at least one channel of the rolling bearing as well as the at least one radial channel of the camshaft.

A pressure medium transfer element of the rolling bearing or a rolling bearing component designed for pressure medium transfer may be connected, in particular rotatably fixedly, to the camshaft. With respect to the cylinder head-affixed component, the pressure medium transfer element of the rolling bearing or the rolling bearing component designed for pressure medium transfer may be rotatably supported. The pressure medium channel may empty into an annular channel of the pressure medium transfer element of the rolling bearing or of the rolling bearing component designed for pressure medium transfer via an annular channel opening, in particular radially, for example directly, or for example indirectly via another (mounting) radial channel and/or (mounting) annular channel. The at least one radial channel of the pressure medium transfer element of the rolling bearing or of the rolling bearing component designed for pressure medium transfer may empty into at least one radial channel of the camshaft, in particular radially, for example directly, or for example via another radial channel and/or annular channel.

Additionally or alternatively, a pressure medium transfer element of the rolling bearing or a rolling bearing component designed for pressure medium transfer may be connected, in particular fixedly, to the stationary, in particular cylinder head-affixed, component. The pressure medium transfer element of the rolling bearing or the rolling bearing component designed for pressure medium transfer may be situated, in particular, in a stationary manner, with respect to the camshaft. The at least one radial channel of the camshaft may empty into an annular channel of the pressure medium transfer element of the rolling bearing or of the rolling bearing component designed for pressure medium transfer via an annular channel opening, in particular radially, for example directly, or for example indirectly via another (mounting) radial channel and/or (mounting) annular channel. The at least one radial channel of the pressure medium transfer element of the rolling bearing or of the rolling bearing component designed for pressure medium transfer may empty into a pressure medium channel of the stationary, in particular cylinder head-affixed, component, in particular radially, for example directly or, for example indirectly via another radial channel and/or annular channel.

### BRIEF DESCRIPTION OF THE DRAWINGS

The present invention is explained by way of example below on the basis of preferred exemplary embodiments with reference to the appended drawings, the features illustrated below being able to represent one aspect of the present invention both individually and in combination.

FIG. 1 shows a schematic cross section of a first specific embodiment, which includes a pressure medium transfer element situated between the rolling bearing inner ring and the rolling bearing outer ring;

FIG. 2 shows a schematic cross section of a second specific embodiment, which includes a rolling bearing cage ring designed for pressure medium transfer;

FIG. 3 shows a schematic cross section of a third specific embodiment, which includes a rolling bearing inner ring designed for pressure medium transfer;

FIG. 4 shows a schematic cross section of a fourth specific embodiment, in which both the rolling bearing inner ring and the rolling bearing outer ring are designed for pressure medium transfer;

FIG. 5 shows a schematic cross section detail of a fifth specific embodiment, which includes a pressure medium transfer element having an annular base body fastened to the rolling bearing inner ring in the form of an annular U profile as well as having sealing rings;

FIG. 6 shows a schematic cross section detail of a sixth specific embodiment, which includes a pressure medium transfer element having an annular base body fastened to the rolling bearing inner ring in the form of an annular U profile, which also functions as a compression seal; and

FIG. 7 shows a schematic cross section detail of a seventh specific embodiment, which includes a pressure medium transfer element having an annular base body, loosely or floatingly supported, in the form of an annular U profile, which also functions as a compression seal.

### DETAILED DESCRIPTION

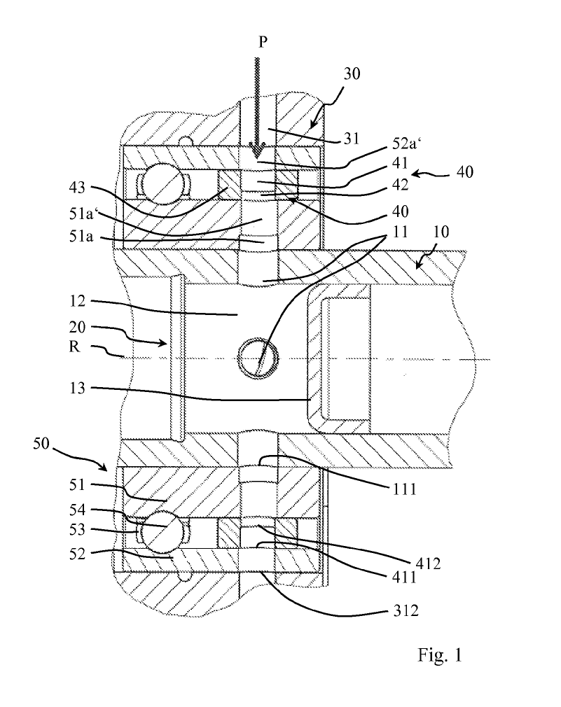

FIGS. 1 through 4 show camshaft assemblies which include a camshaft 10 and a hydraulic phase adjusting device 20 for adjusting the phase angle of camshaft 10 with respect to a crankshaft with the aid of a hydraulic pressure medium P. Camshaft 10 includes multiple radial channels 11, which communicate with phase adjusting device 20 via interior 12 of camshaft 10. At least one part of phase adjusting device 20 is situated inside camshaft 10. Camshaft 10 has an essentially tube-shaped design. Interior 12 is delimited by phase adjusting device 20, on the one hand, and by a closing element 13, on the other hand.

Camshaft 10 is rotatably supported around a rotation axis R with respect to a cylinder head-affixed component 30 via a rolling bearing 50. At least one part of camshaft 10 projects into cylinder head-affixed component 30.

Cylinder head-affixed component 30 includes a pressure medium channel 31 in the form of a radial channel, which extends radially outward from radial channels 11 of camshaft 10.

Rolling bearing 50 includes a rolling bearing inner ring 51, a rolling bearing outer ring 52 and a rolling bearing ball cage ring 53 situated therebetween, with rolling bearing balls 54 accommodated therein. Rolling bearing inner ring 51 is, in particular, rotatably fixedly fastened to an outer lateral surface of camshaft 10 via an inner lateral surface of rolling bearing inner ring 51. Rolling bearing outer ring 52 is fastened to an inner lateral surface of cylinder head-affixed component 30 via an outer lateral surface of rolling bearing outer ring 52. Camshaft 10 and rolling bearing inner ring 51 are rotatable components, and rolling bearing outer ring 52 and cylinder head-affixed component 30 are stationary components. Rolling bearing ball cage ring 53 may be loosely or floatingly supported and situated, for example, between rolling bearing inner ring 51 and rolling bearing outer ring 52, secured only against an axial movement, and it may, if necessary, be rotatable together with a rotary motion of rolling bearing inner ring 51. Alternatively, rolling bearing ball cage ring 53 may be fastened either to rolling bearing inner ring 51 or to rolling bearing outer ring 52 or integrated therein.

FIGS. 1 through 7 show that rolling bearing 50 includes at least one channel 41, 42, 45, 41*, 42*, 45*, 51a, 51b, 51a′, 52a, 52b, 52a′, 53a, 53b, 53a′ for conducting hydraulic pressure medium P.

For the purpose of transferring hydraulic pressure medium P from a stationary component 31, 30 to a rotatable component 11, 10, rolling bearing 50, within the scope of FIGS. 1, 5, 6 and 7, includes a pressure medium transfer element 40 in the form of an independent component or an independent component arrangement.

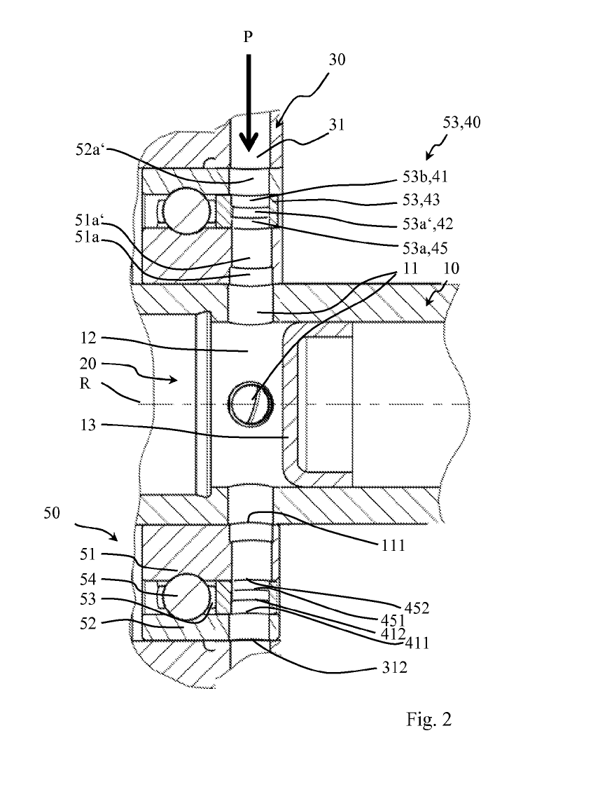

Within the scope of the specific embodiments illustrated in FIGS. 2, 3 and 4, at least one rolling bearing component 53, 51, 52 is designed to transfer hydraulic pressure medium P from a stationary component 31, 30 to a rotatable component 11, 10 and is itself used as pressure medium transfer element 40, 40*.

Pressure medium transfer element or rolling bearing components 40, 40*, 53, 51, 52 designed for pressure medium transfer each include one or multiple annular channels 41, 45, 41*,45*, each of which has an annular channel opening 411, 452, 412*,451* extending in the circumferential direction of the annular channel 41, 45, 41*,45*, and at least one radial channel opening 412, 451, 411*, 452* opposite annular channel opening 411, 452, 412*, 451* and emptying into a radial channel 42, 42*, 11. It is facilitated that a channel of the stationary component, in particular pressure medium channel 31 of cylinder head-affixed component 30, communicates with a channel of the rotatable component, in particular radial channels 11 of camshaft 10, via annular channel opening 411, 452, 412*, 451* and the at least one radial channel opening 412, 451, 411*, 452* of annular channel(s) 41, 45, 41*,45* of pressure medium transfer elements 40, 40*.

To conduct pressure medium P past the ball cage of rolling bearing 50 and not through it, rolling bearing inner ring 51 or rolling bearing inner ring 51 and rolling bearing outer ring 52 and possibly also rolling bearing ball cage ring 53 have an axially elongated design.

Within the scope of the specific embodiment illustrated in FIG. 1, rolling bearing 50 includes not only rolling bearing inner ring 51, rolling bearing outer ring 52 and rolling bearing ball cage ring 53, with rolling bearing balls 54 situated therein, but also a pressure medium transfer element 40, which includes an annular channel 41 having a radially outer annular channel opening 411 extending in the circumferential direction of annular channel 41 and multiple radially inner radial channel openings 412 opposite annular channel opening 411 as well as multiple radial channels 42 which each empty into one of radial channel openings 412 of annular channel 41.

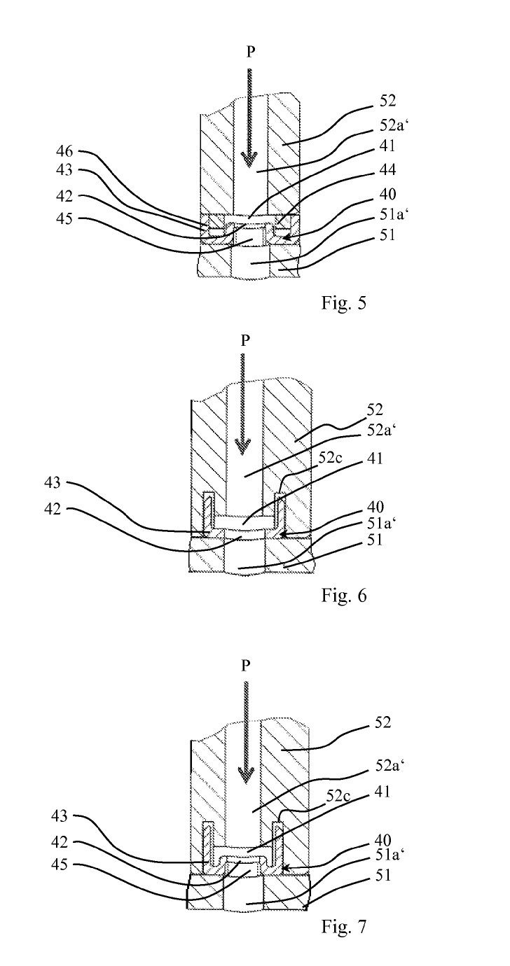

Pressure medium transfer element 40 is an independent annular component or component arrangement. Pressure medium transfer element 40 may include, for example, an annular base body 43, in which annular channel 41 is provided in the form of an annular grove, multiple radial channels 42 extending through annular base body 43 and emptying into annular groove-shaped annular channel 41. Alternatively—as explained in greater detail in FIGS. 5 through 7—pressure medium transfer element 40 includes an annular base body 43 in the form of an annular U profile having an essentially axially oriented profile middle section and two profile side sections extending radially outwardly, radial channels 42 extending through the profile middle section.

FIG. 1 shows that pressure medium transfer element 40 is situated between rolling bearing inner ring 51 and rolling bearing outer ring 52. In the specific embodiment illustrated in FIG. 1, pressure medium transfer element 40 is fastened to rolling bearing inner ring 51, in particular the lateral surface thereof 51, in particular via its inner lateral surface. However, it is also possible to fasten pressure medium transfer element 40 to a different component of rolling bearing 50, for example rolling bearing outer ring 52 or rolling bearing ball cage ring 53, or to situate pressure medium transfer element 40, loosely or floatingly supported, between rolling bearing inner ring 51 and rolling bearing outer ring 52 (not illustrated), whereby pressure medium transfer element 40 should then have a different design.

For the purpose of fastening to the rolling bearing outer ring, the pressure medium transfer element may have, for example, a reversed design and include an annular channel having a radially inner annular channel opening extending in the circumferential direction of the annular channel and multiple radially outer radial channel openings opposite the annular channel opening as well as multiple radial channels which each empty into one of the radial channel openings of the annular channel (not illustrated).

For the purpose of fastening to the rolling bearing ball cage ring or for a loosely or floatingly supported arrangement, the pressure medium transfer element may include, for example, an annular channel having a radially inner annular channel opening extending in the circumferential direction of the annular channel and multiple radially outer radial channel openings, an annular channel having a radially outer annular channel opening extending in the circumferential direction of the annular channel as well as multiple radial channels, which each connect the annular channel having the radially outer annular channel opening to the annular channel having the radially inner annular channel opening (not illustrated). In a loosely or floatingly supported arrangement, the position of the pressure medium transfer element may be secured or blocked radially by the rolling bearing inner ring and the rolling bearing outer ring. The position of the pressure medium transfer element may be secured or blocked axially by the rolling bearing ball cage ring and/or the rolling bearing inner ring and/or the rolling bearing outer ring and/or, if necessary, one or multiple additional components (not illustrated).

Within the scope of the specific embodiment illustrated in FIG. 1, rolling bearing outer ring 52 includes a radial channel 52a′, and rolling bearing inner ring 51 includes multiple radial channels 51a′ which empty radially into an annular channel 51a of rolling bearing inner ring 51.

Radial channel 52a′ of rolling bearing outer ring 52 empties radially into annular channel 41 of pressure medium transfer element 40, a radially inner opening of radial channel 52a′ of rolling bearing outer ring 52 being situated opposite, in particular directly adjacent to, radially outer annular channel opening 411 of pressure medium transfer element 40. Annular channel 41 of pressure medium transfer element 40, in turn, empties into radial channels 42 of pressure medium transfer element 40. Radial channels 42 of pressure medium transfer element 40, in turn, empty radially into radial channels 51a′ of rolling bearing inner ring 51, radially inner openings of radial channels 42 of pressure medium transfer element 40 being situated opposite, in particular directly adjacent to, radially outer openings of radial channels 51a′ of rolling bearing inner ring 51. In this way, radial channel 52a′ of rolling bearing outer ring 52 communicates with radial channels 51a′ of rolling bearing inner ring 51 via pressure medium transfer element 40, in particular via annular channel 41 and radial channels 42 of pressure medium transfer element 40.

FIG. 1 furthermore shows that pressure medium channel 31 of cylinder head-affixed component 30 empties radially into radial channel 52a′ of rolling bearing outer ring 52, a radially inner opening 312 of pressure medium channel 31 being situated opposite, in particular directly adjacent to, a radially outer opening of radial channel 52a′ of rolling bearing outer ring 52. Radial channels 51a′ of rolling bearing inner ring 51 empty into annular channel 51a of rolling bearing inner ring 51. Annular channel 51a of rolling bearing inner ring 51, in turn, empties radially into radial channels 11 of camshaft 10, a radially inner annular channel opening of annular channel 51a of rolling bearing inner ring 51 being situated opposite, in particular directly adjacent to, radially outer openings of radial channels 11 of camshaft 10. In this way, pressure medium channel 31 communicates with radial channels 11 of camshaft 10 via radial channel 52a′ of rolling bearing outer ring 52 and via pressure medium transfer element 40, in particular via annular channel 41 and radial channels 42 of pressure medium transfer element 40 and via radial channels 51a′ and annular channel 51a of rolling bearing inner ring 51 and, in turn, with hydraulic phase adjusting device 20 via radial channels 11 as well as interior 12 of camshaft 10. A pressure medium transfer from stationary pressure medium channel 31 of cylinder head-affixed component 30 to rotatable radial channels 11 of camshaft 10 and, in particular to rotatably situated phase adjusting device 20, may thus be advantageously implemented.

Within the scope of the embodiment illustrated in FIG. 1, annular channel 51a of rolling bearing inner ring 51 is used, in particular, to avoid an angle-oriented alignment of rolling bearing inner ring 51 with respect to radial channels 11 of camshaft 10 during mounting and makes it possible to advantageous simplify the mounting of rolling bearing inner ring 51 onto camshaft 10.

In the specific embodiment illustrated in FIG. 1, however, pressure medium transfer element 40 should be mounted in an angle-oriented manner with respect to radial channels 51a′ of rolling bearing inner ring 51 on rolling bearing inner ring 51, and rolling bearing outer ring 52 should be mounted in an angle-oriented manner with respect to pressure medium channel 31 of cylinder head-affixed component 30.

To avoid these angle orientations as well or to increase their tolerance range (not illustrated), a (mounting) annular channel and/or a (mounting) radial channel having a radial channel opening enlarged axially and/or in the circumferential direction may be provided between the radial channel of the pressure medium transfer element and the radial channel of the rolling bearing inner ring and/or between the radial channel of the rolling bearing outer ring and the pressure medium channel, which may be provided, for example in the pressure medium transfer element or the rolling bearing inner ring or in the rolling bearing outer ring or the cylinder head-affixed component. An angle-oriented mounting may be avoided with the aid of a (mounting) annular channel. With the aid of a (mounting) radial channel having a radial channel opening which is enlarged axially and/or in the circumferential direction, in particular compared to the adjacent openings, at least the tolerance range of the angle orientation may be advantageously increased and the mounting simplified thereby.

Within the scope of the specific embodiment illustrated in FIG. 1, a sealing of the pressure medium transfer system may be implemented with the aid of a clearance fit between pressure medium transfer element 40 and rolling bearing outer ring 52. However, it is also conceivable to implement a seal with the aid of sealing rings or a compression seal (see FIGS. 5 through 7).

The specific embodiment illustrated within the scope of FIG. 2 essentially differs from the specific embodiment illustrated in FIG. 1 in that pressure medium transfer element 40 is fastened to rolling bearing ball cage ring 53, or it is integrated therein, which means that rolling bearing ball cage ring 53 itself includes channels 53b, 41; 53a′, 42; 53a, 45 for transferring hydraulic pressure medium P from a stationary component 31, 30 to a rotatable component 11, 10.

Rolling bearing ball cage ring 53 may be fastened to rolling bearing inner ring 51 or to rolling bearing outer ring 52 as well as loosely or floatingly supported or rotatably situated with respect to rolling bearing inner ring 51 and rolling bearing outer ring 52.

For this reason or—as explained in greater detail in connection with FIG. 1—to avoid an angle-oriented mounting, the specific embodiment illustrated in FIG. 2 also differs from the specific embodiment illustrated in FIG. 1 in that pressure medium transfer element 40 or rolling bearing ball cage ring 53 includes not only one, in particular outer, annular channel 53b, 41 but also two annular channels 53b, 41; 53a, 45 connected to each other via radial channels 53a′, 42, the one annular channel 53b, 41 being formed radially outwardly from the other annular channel 53a, 45, and radial channels 53a′, 42 extending radially between the two annular channels 53b, 41; 53a, 45.

Outer annular channel 53b, 41 of pressure medium transfer element 40 or of rolling bearing call cage ring 53 has a radially outer annular channel opening 411 and multiple radially inner radial channel openings 412, inner annular channel 53a, 45 of pressure medium transfer element 40 or of rolling bearing ball cage ring 53 having a radially inner annular channel opening 452 and multiple radially outer radial channel openings 451. Radial channels 53a′, 42 of pressure medium transfer element 40 or of rolling bearing ball cage ring 53 connect outer annular channel 53b, 41 having radially outer annular channel opening 411 of pressure medium transfer element 40 or of rolling bearing ball cage ring 53 to inner annular channel 53a, 45 having radially inner annular channel opening 452 of pressure medium transfer element 40 or of rolling bearing ball cage ring 53 and each empty into outer annular channel 53b, 41 of pressure medium transfer element 40 or of rolling bearing ball cage ring 53 via a radially inner outer radial channel opening 412, on the one hand, and into inner annular channel 53a, 45 of pressure medium transfer element 40 or of rolling bearing ball cage ring 53 via a radially outer inner radial channel opening 451, on the other hand.

Radial channel 52a′ of rolling bearing outer ring 52 empties radially into outer annular channel 53b, 41 of pressure medium transfer element 40 or of rolling bearing ball cage ring 53, a radially inner opening of radial channel 52a′ of rolling bearing outer ring 52 being situated opposite, in particular, directly adjacent to, radially outer annular channel opening 411 of pressure medium transfer element 40 or of rolling bearing ball cage ring 53. Outer annular channel 53b, 41 of pressure medium transfer element 40 or of rolling bearing ball cage ring 53, in turn, empties into inner annular channel 53a, 45 of pressure medium transfer element 40 or of rolling bearing ball cage ring 53 via radial channels 53a′, 42 of pressure medium transfer element 40 or rolling bearing ball cage ring 53. Inner annular channel 53a, 45 of pressure medium transfer element 40 or rolling bearing ball cage ring 53, in turn, empties radially into radial channels 51a′ of rolling bearing inner ring 51, radially inner annular channel opening 452 of inner annular channel 53a, 45 of pressure medium transfer element 40 or of rolling bearing ball cage ring 53 being situated opposite, in particular, directly adjacent to, radially outer openings of radial channels 51a′ of rolling bearing inner ring 51. In this way, radial channel 52a′ of rolling bearing outer ring 52 communicates with radial channels 51a′ of rolling bearing inner ring 51 via pressure medium transfer element 40, in particular rolling bearing ball cage ring 53, in particular via annular channels 53b, 41; 53a, 45 and radial channels 53a′, 42 of pressure medium transfer element 40 or rolling bearing ball cage ring 53.

Radial channels 51a′ of rolling bearing inner ring 51 empty into annular channel 51a of rolling bearing inner ring 51. Annular channel 51a of rolling bearing inner ring 51, in turn, empties radially into radial channels 11 of camshaft 10, a radially inner annular channel opening of annular channel 51a of rolling bearing inner ring 51 being situated opposite, in particular, directly adjacent to, radially outer openings of radial channels 11 of camshaft 10.

Pressure medium channel 31 of cylinder head-affixed component 30 empties radially into radial channel 52a′ of rolling bearing outer ring 52, a radially inner opening 312 of pressure medium channel 31 being situated opposite, in particular, directly adjacent to, a radially outer opening of radial channel 52a′ of rolling bearing outer ring 52.

In this way, pressure medium channel 31 communicates with radial channels 11 of camshaft 10 via radial channel 52a′ of rolling bearing outer ring 52 and via pressure medium transfer element 40 or rolling bearing ball cage ring 53, in particular via annular channels 53b, 41; 53a, 45 and radial channels 53a′, 42 of pressure medium transfer element 40 or of rolling bearing ball cage ring 53 and via radial channels 51a′ and annular channel 51a of rolling bearing inner ring 51 and, in turn, with hydraulic phase adjusting device 20 via radial channels 11 as well as interior 12 of camshaft 10. A pressure medium transfer from stationary pressure medium channel 31 of cylinder head-affixed component 30 to rotatable radial channels 11 of camshaft 10 and, in particular, to rotatably situated phase adjusting device 20 may thus be advantageously implemented.

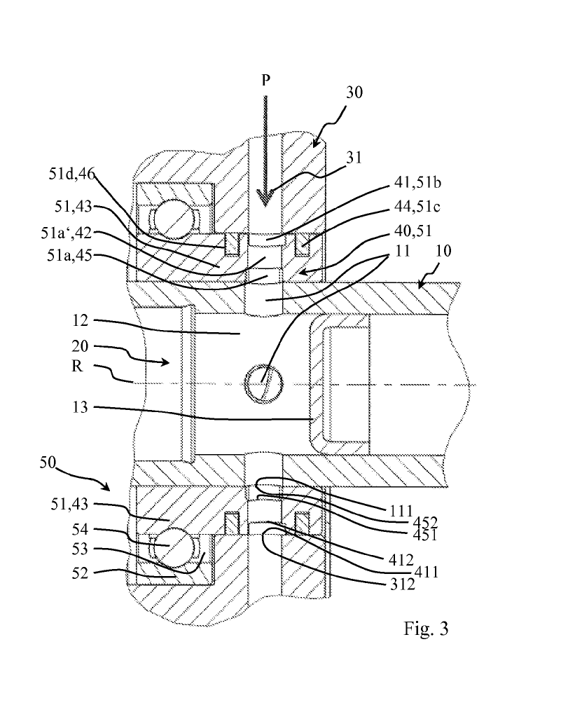

Within the scope of the specific embodiment illustrated in FIG. 3, rolling bearing 50, in particular rolling bearing inner ring 51, is designed to transfer hydraulic pressure medium P from a stationary component 30 to a rotatable component 10. Rolling bearing inner ring 51, 43 is designed to be elongated axially with respect to rolling bearing outer ring 52 and rolling bearing ball cage ring 53 and includes an outer annular channel 51b, 41 having a radially outer annular channel opening 411 extending in the circumferential direction of outer annular channel 51b, 41 and multiple radially inner radial channel openings 412 opposite annular channel opening 411, and an inner annular channel 51a, 45 having a radially inner annular channel opening 452 extending in the circumferential direction of inner annular channel 51a, 45 and multiple radially outer radial channel openings 451 opposite annular channel opening 452, as well as radial channels 51a′, 42 which connect outer annular channel 51b, 41 having radially outer annular channel opening 411 to inner annular channel 51a, 45 having radially inner annular channel opening 452 and each emptying, in particular, into one of radial channel openings 412, 451 of the two annular channels 51b, 41; 51a, 45.

Within the scope of the specific embodiment illustrated in FIG. 3, pressure medium channel 31 empties, in particular, directly into outer annular channel 51b, 41 of rolling bearing inner ring 51, in particular, a radially inner opening 312 of pressure medium channel 31 being situated opposite, in particular, directly adjacent to, radially outer annular channel opening 411 of rolling bearing inner ring 51. Inner annular channel 51a, 45 of rolling bearing inner ring 51 empties, in particular radially, into radial channels 11 of camshaft 10, radially inner annular channel opening 452 of inner annular channel 51a, 45 of rolling bearing inner ring 51 being situated opposite, in particular directly adjacent to, radially outer openings 111 of radial channels 11 of camshaft 10.

Since outer annular channel 51b, 41 of rolling bearing inner ring 51 is connected to inner annular channel 51a, 45 of rolling bearing inner ring 51 by radial channels 51a′, 42 of rolling bearing inner ring 51, it is thus made possible that, in particular, stationary pressure medium channel 31 communicates with, in particular, rotatable radial channels 11 of camshaft 10 via the two annular channels 51b, 41; 51a, 45 and radial channels 51a′, 42 of rolling bearing inner ring 51 and with hydraulic phase adjusting device 20 via these radial channels 11 as well as interior 12 of camshaft 10.

FIG. 3 furthermore shows that sealing rings 51c, 44 may also be used instead of one or multiple clearance fits to seal the pressure medium transfer system. FIG. 3 shows that pressure rolling bearing inner ring 51 includes two sealing rings 51c, 44, which extend essentially in parallel to the two axially outer sides of outer annular channels 51b, 41. Sealing rings 51c, 44 are situated in sealing ring receptacles 51d, 46, which are provided in the form of annular indentations in the outer lateral surface of rolling body inner ring 51 and which extend essentially in parallel to the two axially outer sides of outer annular channels 51b, 41. Within the scope of the specific embodiment illustrated in FIG. 3, rolling bearing inner ring 51 is fastened to the outer lateral surface of camshaft 10 via its inner lateral surface. Due to the fixed connection, within the scope of this specific embodiment, additional sealing ring receptacles and sealing rings in the inner lateral surface of annular base body may be dispensed with.

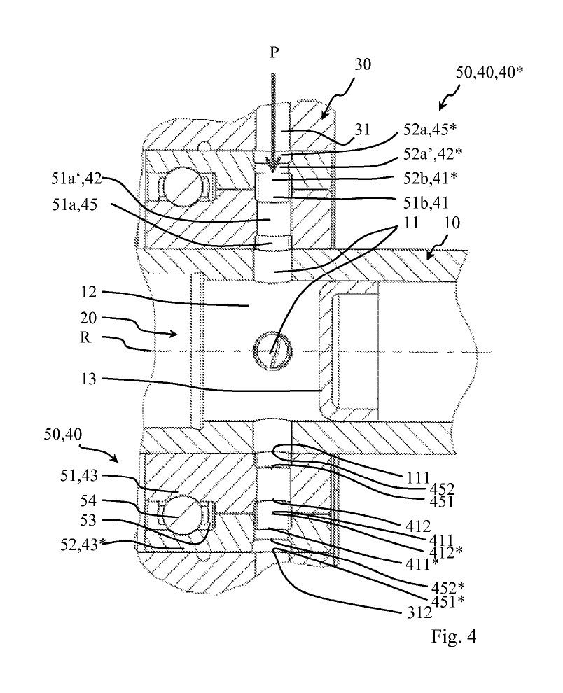

FIG. 4 shows another specific embodiment, in which both rolling bearing inner ring 51 and rolling bearing outer ring 52 are designed to transfer hydraulic pressure medium P from a stationary component 31, 30 to a rotatable component 11, 10 and are themselves used as pressure medium transfer elements 40, 40*.

Rolling bearing inner ring 51 includes an annular channel 51b, 41 having a radially outer annular channel opening 411 and multiple radially inner radial channel openings 412, an annular channel 51a, 45 having a radially inner annular channel opening 452 and multiple radially outer radial channel openings 451 as well as multiple radial channels 51a′, 42, which connect annular channel 51b, 41 having radially outer annular channel opening 411 of rolling bearing inner ring 51 to annular channel 51b, 45 having radial inner annular channel opening 451 of rolling bearing inner ring 51. Radial channels 51a′, 42 of rolling bearing inner ring 51 each empty into a radially inner radial channel opening 412 of annular channel 51b, 41 having radially outer annular channel opening 411 of rolling bearing inner ring 51 and into a radially outer radial channel opening 451 of annular channel 51a, 45 having radially inner annular channel opening 411 of rolling bearing inner ring 51.

Rolling bearing outer ring 52 also includes an annular channel 52a, 45* having a radially outer annular channel opening 451* and multiple radially inner radial channel openings 452*, an annular channel 52b, 41* having a radially inner annular channel opening 412* and multiple radially outer radial channel openings 411* as well as multiple radial channels 52a′, 42*, which connect annular channel 52a, 45* having radially outer annular channel opening 451* of rolling bearing outer ring 52 to annular channel 52b, 41* having radially inner annular channel opening 412* of rolling bearing outer ring 52. Radial channels 52a′, 42* of rolling bearing outer ring 52 each empty into a radial inner radial channel opening 452* of annular channel 52a, 45* having radially outer annular channel opening 451* of rolling bearing outer ring 52 and into a radially outer radial channel opening 411* of annular channel 52b, 41* having radially inner annular channel opening 412* of rolling bearing outer ring 52.

Rolling bearing inner ring 51 and rolling bearing outer ring 52 have an axially elongated design with respect to rolling bearing ball cage ring 53, rolling bearing inner ring 51 and rolling bearing outer ring 52 being directly adjacent to and opposite each other in the sections designed for pressure medium transfer and, in particular, rolling bearing ball cage ring 53 not extending between the sections of rolling bearing inner ring 51 and rolling bearing outer ring 52 designed for pressure medium transfer.

Within the scope of the specific embodiment illustrated in FIG. 4, a sealing of the pressure medium transfer system may be implemented, in particular, with the aid of a clearance fit between surfaces facing one another of rolling bearing inner ring 51 and rolling bearing outer ring 52.

Radially inner annular channel opening 412* of annular channel 52b, 41* of rolling bearing outer ring 52 is directly adjacent to and opposite radially outer annular channel opening 411 of annular channel 51b, 41 of rolling bearing inner ring 51.

As a result, inner annular channel 52b, 41* of rolling bearing outer ring 52 empties radially into outer annular channel 51b, 41 of rolling bearing inner ring 51.

Since outer annular channel 52a, 45* of rolling bearing outer ring 52 empties into inner annular channel 52b, 41* of rolling bearing outer ring 52 via radial channels 52a′, 42* of rolling bearing outer ring 52, and outer annular channel 51b, 41 of rolling bearing inner ring 51 empties into inner annular channel 51a, 45 of rolling bearing inner ring 51 via radial channels 51a′, 42 of rolling bearing inner ring 51, outer annular channel 52a, 45* of rolling bearing outer ring 52 may communicate with inner annular channel 51a, 45 of rolling bearing inner ring 51 in this way.

FIG. 4 furthermore shows that pressure medium channel 31 of cylinder head-affixed component 30 empties radially into outer annular channel 52a, 45* of rolling bearing outer ring 52, a radially inner opening 312 of pressure medium channel 31 being situated opposite, in particular, directly adjacent to, radially outer annular channel opening 411 of outer annular channel 52a, 45* of rolling bearing outer ring 52. Inner annular channel 51a, 45 of rolling bearing inner ring 51 empties into radial channels 11 of camshaft 10, radially inner annular channel opening 452 of inner annular channel 51a, 45 of rolling bearing inner ring 51 being situated opposite, in particular, directly adjacent to, radially outer openings 111 of radial channels 11 of camshaft 10. In this way, pressure medium channel 31 communicates with radial channels 11 of camshaft 10 via annular channels 52a, 45*; 52b, 41* and radial channels 52a′, 42* of rolling bearing outer ring 52 and annular channels 51b, 41; 51a, 45 and radial channels 51a′, 42 of rolling bearing inner ring 51. A pressure medium transfer from stationary pressure medium channel 31 of cylinder head-affixed component 30 to rotatable radial channels 11 of camshaft 10 and, in particular, to rotatably situated phase adjusting device 20 may thus be advantageously implemented.

Within the scope of the embodiment illustrated in FIG. 4, outer annular channel 52a, 45* of rolling bearing outer ring 52 and inner annular channel 51a, 45 of the rolling bearing inner ring are used, in particular, to avoid an angle-oriented alignment of rolling bearing outer ring 52 with respect to pressure medium channel 31 or of rolling bearing inner ring 51 with respect to radial channels 11 of camshaft 10 during mounting and make it possible to advantageous simplify the mounting of rolling bearing outer ring 52 on cylinder head-affixed component 30 and of rolling bearing inner ring 51 on camshaft 10.

FIGS. 5 through 7 show enlarged schematic cross sectional views to illustrate different embodiments of pressure medium transfer elements 40 or sealing concepts.

In particular, FIGS. 5 through 7 show pressure medium transfer elements 40, which include an annular base body 43 in the form of an annular U profile, which includes an essentially axially oriented profile middle section and two profile side sections extending radially outwardly, radial channels 42 extending through the profile middle section.

FIGS. 5 and 7 show that essentially may be understood to mean, in particular, that—to the extent that the profile side sections of the cross-sectional surface have a similar, in particular radial, extension to one another—the intermediate profile middle section may have shape deviations and may be provided, for example, with a wavy or bent design, as illustrated in FIG. 5 or 7.

Pressure medium transfer elements 40, which are designed as explained within the scope of FIGS. 5 through 7, may be used, for example, in the specific embodiments illustrated within the scope of FIG. 1 or 2 and be situated, in particular, between rolling bearing inner ring 51 and rolling bearing outer ring 52.

Within the scope of the specific embodiment illustrated in FIG. 5, the profile middle section has, in particular, two lateral subsections, which are bent radially inwardly, and one subsection, which extends therebetween and is bent radially outwardly. Radial channels 42 extend through the subsection bent radially outwardly, the two lateral subsections bent radially inwardly being used as sealing ring receptacles 46 for sealing rings 44. A profile having a cross section of this type may generally also be referred to as a W profile or an M profile, it being possible to view this as a special type of U profile.

An outer annular channel 41 is provided by the profile middle section and the two profile side sections connected thereto and extending radially outwardly, an inner annular channel 45 being provided by the two lateral subsections bent radially inwardly and the subsection of the profile middle section extending therebetween and bent radially outwardly.

The specific embodiment illustrated within the scope of FIG. 6 has in common with the specific embodiment illustrated in FIG. 5 the fact that pressure medium transfer element 40 includes an annular base body 43 in the form of an annular U profile having an axially oriented profile middle section and two profile side sections extending radially outwardly, radial channels 42 extending through the profile middle section. In contrast to the specific embodiment illustrated in FIG. 5, the profile middle section here is, however, provided with an axially linear or planar and not a wavy design, for which reason annular base body 43 has only one outer annular channel 41 within the scope of the specific embodiment illustrated in FIG. 6.

Moreover, in contrast to the specific embodiment illustrated in FIG. 5—instead of sealing rings—a compression seal is used for sealing the pressure medium transfer system, annular base body 43 of pressure medium transfer element 40 itself functioning as a compression seal. The sealing effect is achieved by the fact that the profile side sections are pressed against the adjacent component to be sealed, in this case rolling body outer ring 52, upon the application of pressure medium. Rolling bearing outer ring 52 includes a compression sealing contact and accommodating section 52c, against which the profile side sections of annular base body 43 are pressed upon the application of pressure medium. Annular base body 43 is fastened to the outer lateral surface of rolling bearing inner ring 51 via the inner lateral surface of the profile middle section.

In contrast to the specific embodiment illustrated in FIG. 6, within the scope of the specific embodiment illustrated in FIG. 7, annular base body 43 is supported loosely or floatingly between rolling bearing inner ring 51 and rolling bearing outer ring 52. Within the scope of the specific embodiment illustrated in FIG. 7, the profile middle section is furthermore not axially linear or planar, as in the specific embodiment illustrated in FIG. 6, but rather only essentially axial, namely wavy, and designed similarly to the specific embodiment illustrated in FIG. 5, for which reason annular base body 43 within the scope of the specific embodiment illustrated in FIG. 7 has an outer annular channel 41 and an inner annular channel 45.

Since annular base body 43 is situated in a loosely or floatingly supported manner, its radial and axial positions are stabilized by compression sealing contact and accommodating section 52c of rolling bearing outer ring 52. Upon the application of pressure medium, not only the profile side sections are pressed against compression sealing contact and accommodating section 52c, but the lateral subsections of the profile middle section, bent radially to the inside, are also pressed against the outer lateral surface of rolling bearing inner ring 51. Inner radial channel 45 of annular base body 43 makes it possible that a transfer of pressure medium is ensured even with a rotation of annular base body 43 with respect to rolling bearing inner ring 51 and its radial channels 51a′ or with respect to rolling bearing outer ring 52 and its radial channel 52a′ and, in particular, no angle orientation is required.

### LIST OF REFERENCE NUMERALS

10 Camshaft
11 Radial channel
111 Radially outer radial channel opening
12 Camshaft interior
13 Closing element
14 Annular channel
15 Sealing ring
16 Sealing ring receptacle
20 Hydraulic phase adjusting device
30 Cylinder head-affixed component, in particular cylinder head
31 Pressure medium channel
312 Radially inner pressure medium channel opening
40,40* Pressure medium transfer element
41,41* Annular channel
411 Radially outer annular channel opening
411* Radially outer radial channel opening
412 Radially inner radial channel opening
412* Radially inner annular channel opening
42,42* Radial channel
43 Annular base body
44 Sealing ring
45,45* Annular channel
451 Radially outer radial channel opening
451* Radially outer annular channel opening
452 Radially inner annular channel opening
452* Radially inner radial channel opening
46 Sealing ring receptacle
50 Rolling bearing
51 Rolling bearing inner ring
52 Rolling bearing outer ring
53 Rolling bearing ball cage ring
54 Rolling bearing ball
51a,52a,53a Annular channel
51a′,52a′,53a′ Radial channel
51b,52b,53b Annular channel
51c Sealing ring
51d Sealing ring receptacle
52c Compression sealing contact and accommodating section
P Pressure medium
R Rotation axis of the camshaft

What is claimed is:

1-10. (canceled)

11. A rolling bearing comprising:
a rolling bearing inner ring;
a rolling bearing outer ring;
a rolling bearing ball cage ring; and
at least one channel for the purpose of conducting a hydraulic pressure medium.

12. The rolling bearing as recited in claim 11 further comprising at least one pressure medium transfer element situated, floatingly supported, in the rolling bearing, or fastened to the rolling bearing inner ring or to the rolling bearing outer ring or to the rolling bearing ball cage ring or another component of the rolling bearing.

13. The rolling bearing as recited in claim 12 wherein the pressure medium transfer element is fastened to the rolling bearing inner ring or to the rolling bearing outer ring or to the rolling bearing ball cage ring.

14. The rolling bearing as recited in claim 13 wherein at least one pressure transfer element or the rolling bearing inner ring or the rolling bearing outer ring or the rolling bearing ball cage ring or another rolling bearing component includes the channel, the channel being an annular channel.

15. The rolling bearing as recited in claim 14 wherein the rolling bearing inner ring or the rolling bearing outer ring or the rolling bearing ball cage ring includes the annular channel.

16. The rolling bearing as recited in claim 14 wherein the annular channel has an annular channel opening extending in the circumferential direction of the annular channel, and at least one radial channel opening opposite the annular channel opening, and emptying into a radial channel.

17. The rolling bearing as recited in claim 14 wherein the at least one pressure transfer element or the rolling bearing inner ring or the rolling bearing outer ring or the rolling bearing ball cage ring or another rolling bearing component includes at least one radial channel emptying into a radial channel opening of the annular channel.

18. The rolling bearing as recited in claim 11 at least one pressure transfer element or the rolling bearing inner ring or the rolling bearing outer ring or the rolling bearing ball cage ring or another rolling bearing component includes the channel, the channel being an annular channel having a radially outer annular channel opening.

19. The rolling bearing as recited in claim 11 wherein at least one pressure transfer element or the rolling bearing inner ring or the rolling bearing outer ring or the rolling bearing ball cage ring or another rolling bearing component includes the channel, the channel being an annular channel having a radially outer annular channel opening, and further comprising a further annular channel having a radially inner annular channel opening as well as a radial channel connecting the annular channel having the radially outer annular channel opening to the annular channel having the radial inner annular channel opening.

20. The rolling bearing as recited in claim 11 wherein a pressure medium transfer element or the rolling bearing ball cage ring is situated between the rolling bearing inner ring and the rolling bearing outer ring, the pressure medium transfer element or the rolling bearing ball cage includes the channel, the channel being an annular channel having an annular channel opening extending in the circumferential direction of the annular channel and at least one radial channel opening opposite the annular channel opening and emptying into a radial channel, the radial channel emptying into the radial channel opening of at least one annular channel of the pressure medium transfer element or the rolling bearing ball cage ring; the rolling bearing inner ring and the rolling bearing outer ring each including a further radial channel; the further radial channel of the rolling bearing inner ring communicating with the further radial channel of the rolling bearing outer ring via the pressure medium transfer element or the rolling bearing call cage ring.

21. The rolling bearing as recited in claim 20 wherein the further radial channel of the rolling bearing inner ring communicates with the further radial channel of the rolling bearing outer ring via the pressure medium transfer element or the rolling bearing call cage ring via the annular channel and radial channel of the pressure medium transfer element or of the rolling bearing ball cage ring.

22. The rolling bearing as recited in claim 11 wherein the rolling bearing inner ring includes the channel, the channel being an annular channel having a radially outer annular channel opening, and further comprising a further annular channel having a radially inner annular channel opening as well as at least one radial channel connecting the annular channel having the radially outer annular channel opening of the rolling bearing inner ring to the further annular channel having the radially inner annular channel opening of the rolling bearing inner ring, and the rolling bearing outer ring also including a second annular channel having a second radially outer annular channel opening, and further comprising a second annular channel having a second radially inner annular channel opening as well as at least one second radial channel connecting the second annular channel having the second radially outer annular channel opening of the rolling bearing outer ring to the second annular channel having the second radial inner annular channel opening of the rolling bearing outer ring, and the second radially inner annular channel opening of the second annular channel of the rolling bearing outer ring is situated directly adjacent to and opposite the radially outer annular channel opening of the annular channel of the rolling bearing inner ring,

23. The rolling bearing as recited in claim 11 wherein the rolling bearing supports a camshaft having phase angle with respect to a crankshaft adjustable with the aid of the hydraulic pressure medium.

24. A camshaft assembly comprising:
a camshaft;
a hydraulic phase adjusting device for adjusting a phase angle of the camshaft with respect to a crankshaft with the aid of a hydraulic pressure medium;
a pressure medium channel formed in a stationary component; and
the rolling bearing as recited in claim 11 wherein the pressure medium channel communicates with the phase adjusting device via the channel of the rolling bearing.

25. The camshaft assembly as recited in claim 24 wherein the stationary component is a cylinder head-affixed component.
